(19) United States
(12) Patent Application Publication
(10) Pub. No.: US 2009/0109188 A1
(43) Pub. Date: Apr. 30, 2009

(54) INPUT PROCESSING DEVICE

(75) Inventors: Kazuhito OHSHITA, Fukushima-ken (JP); Yoshiyuki Kikuchi, Fukushima-ken (JP); Kenji Watanabe, Fukushima-ken (JP); Shoji Suzuki, Fukushima-ken (JP); Toshio Kawano, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/257,792

(22) Filed: Oct. 24, 2008

(30) Foreign Application Priority Data
Oct. 26, 2007 (JP) 2007-279216

(51) Int. Cl. G06F 3/041

(52) U.S. Cl. 345/173

(57) ABSTRACT

An input processing device includes an input member having an input pad and a detecting section that detects a position where an indicator touches the input pad and a processing section that controls a display state on a display screen on the basis of an input signal obtained from the input member, and while an input tool for drawing at least one of character, symbol, and figure is being displayed on the display screen, the processing section displays a limited frame having a predetermined area on the display screen so as to overlap the input tool, and writes movement locus of the indicator touching the input pad within the limited frame and transfers the movement locus to the input tool such that at least one of the character, symbol, and figure is input to the input tool when the indicator touches the input pad.

### CROSS-REFERENCE TO RELATED APPLICATIONS

The present application claims priority to and contains subject matter related to Japanese Patent Application JP2007-279216 filed in the Japanese Patent Office on Oct. 26, 2007, the entire contents of which is incorporated herein by reference.

### BACKGROUND OF THE DISCLOSURE

1. Technical Field

The present invention relates to an input processing device in which at least a character, symbol, or figure is written by an operation of an input member having a flat input pad and the written state is displayed on a display screen.

2. Related Art

A keyboard or a mouse may be used as an operation input member provided in a personal computer. In a notebook type personal computer, a flat input member having an input pad is provided together with the keyboard. The flat input member detects a change in capacitance between electrodes when an indicator having a low electric potential, such as a human finger, approaches or touches the input pad. Coordinate data can be obtained by the change in capacitance, and the same control signal as when a mouse, which is an external device, is operated is generated on the basis of the coordinate data obtained from the input member in a control unit of the personal computer.

Furthermore, various input tools capable of writing a character or a figure in handwriting are used as application software of a personal computer. As disclosed in Japanese Unexamined Patent Application Publication Nos. 2001-195164, 2002-23938, and 2002-15282, an input region of an input tool is displayed on a display screen when the input tool starts.

A cursor is moved into the input region by using a mouse or an input pad of a flat input member. In addition, a character or a figure may be drawn in the input region by moving the mouse while pressing a button of the mouse to thereby move the cursor in the input region. Alternatively, a character or a figure may also be drawn by operating the input pad with a finger in order to move the cursor in the input region.

In an operation of inputting a character or a figure using a known input tool, however, when an input region of an input tool is displayed on a screen, an operation of starting writing of a character, a figure, and the like by operating a mouse or an input pad to move a cursor into the input region and then pressing a button of the mouse or tapping the input pad was required. For this reason, additional operation and operation time are needed before writing of a character or a figure starts.

In addition, in the case when an input tool displayed on a screen has a horizontally long input region and an operation of writing a plurality of characters sequentially in the input region is performed as disclosed in Japanese Unexamined Patent Application Publication No. 2002-23938, writing of one character is completed by making a finger apart from a button of a mouse or tapping an input pad and then the cursor is moved to an input region for a next character. After moving the cursor into the input region for the next character, it is necessary to press a button of the mouse or tap the input pad in order to resume the writing of a character. For this reason, it was difficult to write a plurality of characters quickly in a sequentially manner.

These and other drawbacks exist.

### SUMMARY OF THE DISCLOSURE

An advantage of some aspects of the invention is that it provides an input processing device capable of quickly starting an operation of writing a character, a symbol, or a figure when an input tool is displayed on a screen by making an operation region of an input pad and an input region of the input tool correspond to each other in a one-to-one manner.

Furthermore, another advantage of some aspects of the invention is that it provides an input processing device capable of quickly performing an operation of writing a plurality of characters in a sequential manner or quickly performing an operation of operating various input switching portions together with an operation of writing a character.

According to an embodiment of the invention, there is provided an input processing device including: an input member having an input pad and a detecting section that detects a position where an indicator touches the input pad; and a processing section that controls a display state on a display screen on the basis of an input signal obtained from the input member. While an input tool for drawing at least one character, symbol, or figure is being displayed on the display screen, the processing section displays a limited frame having a predetermined area on the display screen so as to overlap the input tool, and writes movement locus of the indicator touching the input pad within the limited frame and transfers the movement locus to the input tool such that at least one of the character, symbol, and figure is input to the input tool when the indicator touches the input pad.

In the input processing device according to embodiments of the invention, the limited frame is displayed to overlap the input tool displayed on the screen. In addition, when the indicator moves on the input pad, the movement locus is written in the limited frame and is automatically transferred to the input tool, such that at least one of the character, symbol, and figure can be drawn on the input tool. Thus, since the limited frame corresponding to the input pad in a one-to-one manner is displayed on the input tool, an operator can intuitively see that touching at which position of the input pad leads to drawing the locus at which positions of the limited frame and input tool. As a result, an operation in writing at least one of character, symbol, and figure into the input tool becomes easy.

In addition, by limiting a movement range of a cursor displayed on the display screen within the limited frame while the limited frame is being displayed on the display screen, writing of at least one of character, symbol, and figure can be started immediately without large movement of the cursor on the display screen after the input tool and the limited frame are displayed.

For example, in the input processing device according to the embodiment of the invention, an image of the limited frame is displayed such that an image of the input tool is viewed therethrough.

Since a region for writing of a character and the like on the input tool and a place to be touched by the indicator on the input pad can be displayed to overlap each other by displaying a part or all of the limited frame in a transparent or translucent state, the operator can easily see the positional relationship between the locus input on the input pad and the region for writing of a character and the like on the input tool. This may also be realized by causing an image of the limited frame to have a shape similar to the input pad.

Furthermore, in an input processing device according to an embodiment, processing for sequentially moving a display position of the limited frame within the input tool displayed on the display screen at predetermined intervals may be performed. Also, when a predetermined time elapses after the indicator is apart from the input pad, processing for moving a display position of the limited frame within the input tool displayed on the display screen may be performed. When the input pad is tapped after drawing a character or a symbol within the limited frame by operating the input pad, the display position of the limited frame may be moved by one character.

As described above, in the case of sequentially writing a plurality of characters or symbols in parallel within the input tool, the limited frame moves at predetermined intervals or in a predetermined time after the characters or the symbols are written or by a tapping operation, for example, such that a region used to write the characters or the symbols moves automatically. Accordingly, the plurality of characters or symbols can be quickly drawn within the input tool in a sequential manner. As a result, a troublesome operation of writing one character, completing the input by tapping or the like, and moving a cursor to resume writing of a next character and the like is not necessary.

Furthermore, in an input processing device according to an embodiment, the input pad may be divided into a writing region used to write at least one of the character, symbol, and figure and an operation region other than the writing region and processing for deleting at least one of the character, symbol, and figure transferred into the input tool or inserting at least one of the character, symbol, and figure may be performed.

If an operation of deleting a character or an operation of inserting a character can be performed by using a region of a part of the input pad, it becomes unnecessary to move the cursor to a switching portion of the input tool and operate the cursor after writing a character. As a result, a writing operation can be performed quickly.

Furthermore, in an input processing device according to an embodiment, an operation of writing at least one of the character, symbol, or figure within the limited frame may be released when a specific input operation is performed on the input member, and processing for moving the cursor displayed on the display screen without being restricted to the limited frame may be performed when the indicator moves on the input pad after the release.

For example, the specific input operation may include an operation of tapping the input pad with the indicator. In addition, the specific input operation may be performed by operating a press button provided together with the input pad.

That is, in an input processing device according to an embodiment, when the display of the limited frame starts while the input tool is being displayed, the moving range of the cursor may not be the whole display screen but is restricted to the inside of the limited frame instead at the point of time. Accordingly, it becomes easy to draw a character, a symbol, and the like within the limited frame. In this case, by tapping the input pad or pressing a press button provided together with the input pad, the cursor can be moved to another region without being restricted to the limited frame when moving the indicator on the input pad thereafter. This enables an operation of other icons.

Furthermore, in an input processing device according to an embodiment, the processing section may be executed by software installed in a control unit of a personal computer, and the input tool may also be executed by software installed in the control unit.

In addition, the processing section may be executed by driver software that gives coordinate information to an operating system in the control unit on the basis of the input signal from the input member and limited frame setting application software that sets the limited frame.

According to various embodiments of the invention, at least one of the character, symbol, and figure can be quickly written on the input tool using the input pad. Also, an operation of sequentially writing a plurality of characters or symbols on the input tool can also be performed quickly and correctly.

### BRIEF DESCRIPTION OF THE DRAWINGS

FIG. 1 is a perspective view showing a personal computer including an exemplary input processing device according to an embodiment of the disclosure;

FIG. 2 is plan view showing an exemplary flat input member according to embodiments of the disclosure;

FIG. 3 is a view showing an exemplary circuit block of an input processing device according to embodiments of the disclosure;

FIGS. 4A and 4B illustrate exemplary display states of a display screen according to embodiments of the disclosure; and

FIG. 5 illustrates an exemplary display state of a display screen according to an embodiment of the disclosure.

### DESCRIPTION OF EXEMPLARY EMBODIMENTS

The following description is intended to convey a thorough understanding of the embodiments described by providing a number of specific embodiments and details involving input processing devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

According to various exemplary embodiments, input processing devices are provided.

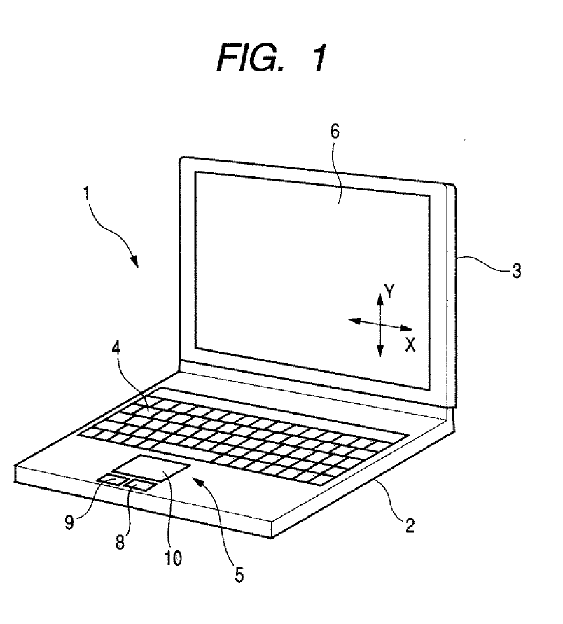

In a personal computer 1 shown in FIG. 1, a main body 2 and a lid portion 3 may be connected together so as to be able to be folded. A keyboard device 4 and a flat input member 5 may be provided in a console panel of a top surface of the main body 2. A display device 6 formed of a liquid crystal display panel or other like display may be provided on a front surface of the lid portion 3.

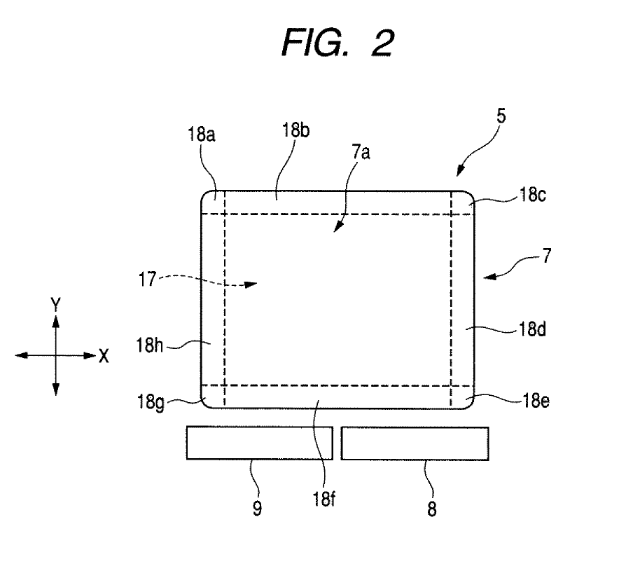

As shown in the enlarged view of FIG. 2, the flat input member 5 may have an input pad 7, a right button 8 which may be located at a lower right side of the input pad 7, and a left button 9 which may be located at a lower left side of the input pad 7.

The input pad 7 may include a flat input screen 7a. The input pad 7 may include a plurality of X electrodes extending in the X direction and a plurality of Y electrodes extending in the Y direction which may face each other with an insulating layer interposed therebetween and has a detection electrode provided between the adjacent X electrodes. A thin insulating sheet may be provided on surfaces of the electrodes, and a surface of the insulating sheet may be referred to as the input screen 7a.

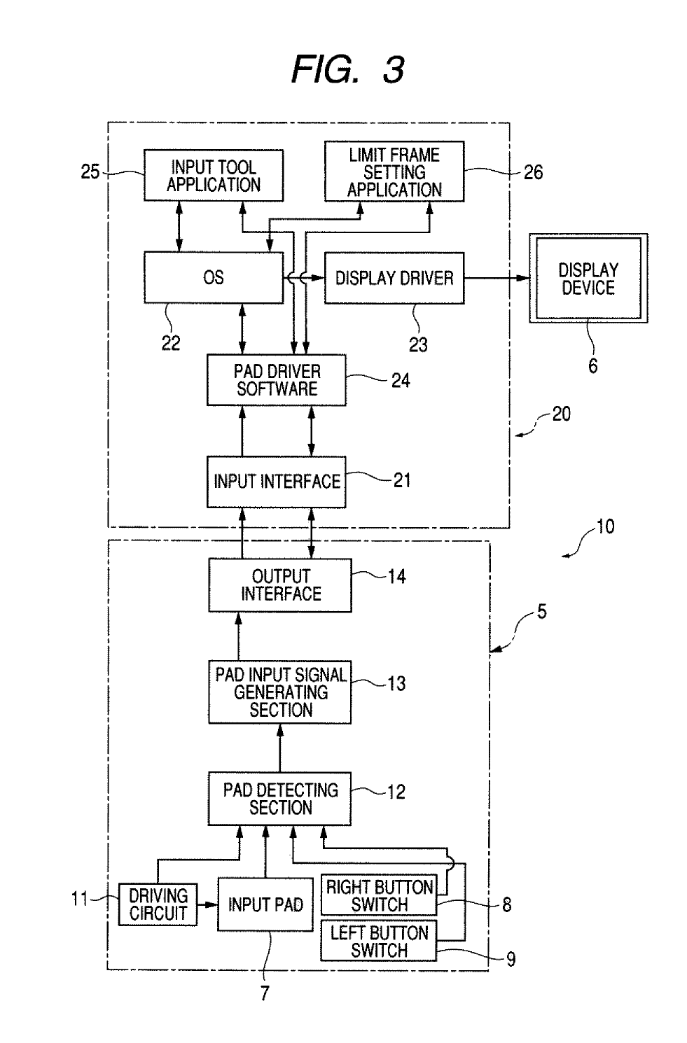

As shown in FIG. 3, a predetermined voltage may be sequentially applied to the X electrodes and a predetermined voltage may be sequentially applied to the Y electrodes at different timing by a driving circuit 11 provided in the input member 5. Since a capacitance is formed between a finger, which is a conductive indicator having an almost ground potential, and each electrode when the finger touches the input screen 7a, the capacitance between a detection electrode and an X electrode may change in a portion which the finger approaches and the capacitance between the detection electrode and a Y electrode changes.

Due to the change in capacitance, a rise time of a pulse shaped voltage applied to the X electrode or Y electrode may be delayed. The delay of the rise time of the voltage at this time may be detected through the detection electrode in a pad detecting section 12. When the delay of a rising edge of the voltage is detected through the detection electrode in the pad detecting section 12, a location which the finger touches can be detected on X-Y coordinates by acquiring timing information on which X electrode or Y electrode is applied with the voltage.

Accordingly, when a finger touching the input screen 7a moves, the movement locus of the finger may be detected on the X-Y coordinates. In addition, since the capacitance between electrodes changes for a short time when a so-called tapping operation of making a finger approach the input screen 7a quickly and apart from the input screen 7a quickly is performed, this can be detected in the pad detecting section 12.

FIG. 3 is a block diagram showing an input processing device 10 provided in the personal computer 1.

As described above, the driving circuit 11 which may apply a pulse shaped voltage to the X electrodes and Y electrodes of the input pad 7 in a sequential manner and the pad detecting section 12 which may detect a change in a rising edge of a voltage of a detection electrode provided in the input pad 7 may be provided in the flat input member 5. By the pad detecting section 12, the contact position of a finger on the input screen 7a can be specified on the X-Y coordinates. In addition, operation signals of the right button 8 and the left button 9 also may be detected by the pad detecting section 12.

A pad input signal generating section 13 may be provided in the input member 5. X-Y coordinate information which may be an operation signal of the input pad 7 detected by the pad detecting section 12, switch input information of the right button 8, and switch input information of the left button 9 may be generated as format data with predetermined bytes in the pad input signal generating section 13 and may be output from an output interface 14. The operation signal output from the output interface 14 may be transmitted to an input interface 21 provided in a control unit 20 of the personal computer. The output interface 14 and the input interface 21 may be USE interfaces, for example.

Various software applications and/or programs may be installed in the control unit 20 of the personal computer 1. An operating system (OS) 22 may also be installed in the control unit 20. The operating system 22 can control a display driver 23 to display various kinds of information on the display device 6.

Driver software 24 for the pad may be installed in the control unit 20, and the operation signal received in the input interface 21 may be transmitted to the driver software 24 for the pad. By the driver software 24 for the pad, a coordinate data signal equivalent to an operation signal of a mouse, which may be an external device, may be generated on the basis of the operation signal which may have a predetermined format and may be transmitted from the pad input signal generating section 13, and the coordinate data signal may be notified to the operating system 22.

Input tool application software 25 also may be installed in the control unit 20. The input tool application software 25 may be used to write a character, a symbol, or a figure using the input pad 7 or a mouse. The input tool application software 25 may perform processing for displaying an image of an input tool board on the display device 6 and processing for specifying a character or a symbol to be written from the locus written through the input pad or the mouse, notifying the operating system 22 of the information, and displaying the specified characteristic or symbol on the display device 6.

Limited frame setting application software 26, which may function as an image processing section, may be installed in the control unit 20. When the limited frame setting application software 26 is started, an image of an input tool board and an image of a limited frame may be displayed on the display device 6 so as to overlap each other. In addition, a movement region of a cursor when operating an input pad with a finger may be restricted within the limited frame and information on the operation locus written within the limited frame may be provided to the input tool application software 25, such that processing for transferring the locus written within the limited frame to the input tool may be performed in the display device 6. Furthermore, in the limited frame setting application software 26, processing including switching of various write modes, such as deletion of a character and insertion of a character using the limited frame, may be performed on the basis of the operation signal of the input pad 7.

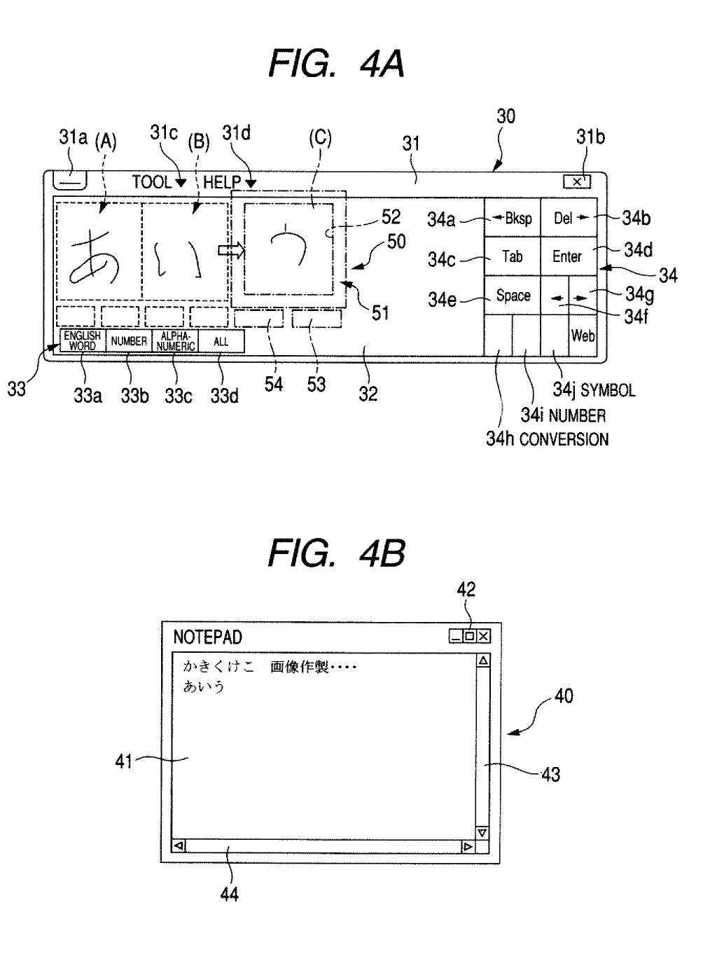

FIGS. 4A and 4B show a state where two input tools and a limited frame may be displayed on a display screen of the display device 6 so as to overlap each other.

The input tool shown in FIG. 4A may be referred to as a handwriting tool board 30, and the input tool shown in FIG. 4B is a character input tool board 40. Handwriting tool board 30 and character input tool board 40 may be displayed on a screen of the display device 6 when the input tool application software 25 shown in FIG. 3 is executed. The handwriting tool board 30 and the character input tool board 40 may be displayed separately within the same screen of the display device 6 or displayed such that parts of the boards 30 and 40 overlap each other.

On the handwriting tool board 30, a character, a number, or a symbol may be written by handwriting using the input pad 7 or a mouse. The handwriting tool board 30 may identify the character, the number, or the symbol written by handwriting, specify which character it is, and notify the character input tool board 40 of the character code. On the character input tool board 40, the character or the symbol may be displayed in the type form on the basis of a font of the character, number, or symbol corresponding to the character code notified from the handwriting tool board 30.

As shown in FIG. 4A, the handwriting tool board 30 displayed on the screen of the display device 6 may have a horizontally long input region 32 inside a horizontally long frame display 31. A minimize button 31a, a close button 31b, and the like may be provided in an upper portion of the frame display 31, for example. Furthermore, menu buttons 31c and 31d may be displayed in the upper portion of the frame display 31.

A conversion selection button display 33 may be provided in a lower left region of the input region 32, for example. The conversion selection button display 33 may include an ‘English word’ button 33a, a ‘number’ button 33b, an ‘alphanumeric’ button 33c, and an ‘all’ button 33d. When display of the ‘English word’ button 33a is highlighted, for example, by tapping the input pad 7 in a state where a cursor is located at the English word button 33a or by pressing the right button 8 to select the English word button 33a, the locus written by handwriting in the input region 32 may be analyzed as an English word. In addition, when the ‘all’ button 33d is selected by tapping the ‘all’ button 33d and the display is highlighted, the locus written in the input region 32 can be analyzed and specified as any of an English word, a number, hiragana, and katakana, for example. In various embodiments, other buttons and associated analysis may be provided. For example, an “emoticon” button may be provided and the handwriting may be analyzed as an emoticon.

On the handwriting tool board 30, an operation panel 34 may be displayed at a right side of the input region 32. The operation panel 34 may be divided into a plurality of operation instructing portions. The operation instructing portions may include, without limitation, a backspace instructing portion 34a, a delete instructing portion 34b, a tab set instructing portion 34c, an insert instructing portion 34d, a space input instructing portion 34e, a left movement instructing portion 34f, and a right movement instructing portion 34g. Furthermore, below those described above, a conversion instructing portion 34h used to convert a kana character string into a Chinese character, a number instructing portion 34i used to select and input a number, and a symbol instructing portion 34j used to select and input various symbols may be provided.

When a cursor is moved to the backspace instructing portion 34a and the input pad is tapped or the cursor is moved to the backspace instructing portion 34a and the right button 8 is pressed, characters written in the input region 32 may be deleted sequentially from the end toward the character string head. By selecting the delete instructing portion 34b by tapping in a state where a cursor is located at the delete instructing portion 34b, highlighting the display of the delete instructing portion 34b, and then making the cursor located at a character or the like, which needs to be deleted, written in the input region 32 for a predetermined time, the character may also be deleted.

When a predetermined number of characters are written in the input region 32 of the handwriting tool board 30, the characters may be displayed in the type form according to a font in a display region 41 of the character input tool board 40. When a ‘kana string’ input to the handwriting tool board 30 is written in the character input tool board 40, the ‘kana string’ automatically may be converted from ‘kana’ to a ‘Chinese character’. In addition, by tapping the conversion instructing portion 34h in a state where the cursor is located at the conversion instructing portion 34h of the operation panel 34 after writing ‘kana’ in the input region 32 of the handwriting tool board 30, a character string of ‘kana’ also may be converted into the Chinese character and may be displayed in the type form according to the font in the display region 41 of the character input tool board 40.

On the character input tool board 40 shown in FIG. 4B, a button display 42 indicating ‘minimize’, ‘maximize’, and ‘close’ for frame display, a vertical scroll bar display 43, and a horizontal scroll bar display 44 may be provided.

In case of performing writing in the input region 32 of the handwriting tool board 30 using the input pad 7, by moving a finger on the input pad 7 to move a cursor to the input region 32 and tapping the input pad 7 and then drawing a character with the finger, the locus may be written in the input region 32. Alternatively, a character and the like may also be written by hand in the input region 32 by moving a cursor to the input region 32 with a mouse and moving the mouse while pressing a right button or a left button.

In the input region 32, a plurality of characters, numbers, or the like may be written sequentially in the horizontal direction. Accordingly, after writing one character or the like, it may be necessary to tap the input pad 7 and then move the cursor to the input position of a next character so that writing of a character or the like can be resumed. Also, a hand may be apart from a right button or a left button of the mouse and the cursor may be moved to the input position of the next character. Then, it may be necessary to resume the writing of the next character.

In the input processing device 10 according to the present embodiment, by starting the limited frame setting application 26 shown in FIG. 3, a region where one character, one number, or one symbol is written can be moved rightward in a sequential manner within the input region 32 of the handwriting tool board 30. As a result, a plurality of characters, numbers, symbols, and the like may be quickly written as a character string by handwriting.

As shown in FIGS. 4A and 4B, when the left button 9 of the input member 5 shown in FIG. 2 is pressed while the handwriting tool board 30 and the character input tool board 40 are being displayed on the display screen of the display device 6, the limited frame setting application software 26 may start to display a limited frame 50 at a position overlapping the input region 32 of the handwriting tool board 30 as shown in FIG. 4A.

Furthermore, as shown in FIG. 2, it may be possible to divide the input screen 7a of the input pad 7 into a plurality of regions beforehand and to assign various operation functions to the regions. It may be set and changed by operating a set menu of the driver software 24 for the pad how to set the number of regions divided or the sizes of regions, which function is to be assigned to each region, and whether to make display of the limited frame 50 effective. In the example shown in FIG. 2, a large writing region 17 may be set in the middle of the input screen 7a of the input pad 7 and eight operation regions indicated by 18a to 18h are set around the writing region 17.

When the limited frame setting application software 26 starts, the limited frame 50 may be displayed in a first region (A) located at the leftmost side of the input region 32 of the handwriting tool board 30. Then, the limited frame 50 may automatically move rightward to thereby move to a second region (B) in a predetermined time (about 3 to 10 seconds) and then move to a third region (C) in a predetermined time. FIG. 4A shows a state where the limited frame 50 may move to the third region (C) and stops. An image of the actual handwriting tool board 30 may be horizontally longer than that shown in FIG. 4A, and eight or more or ten or more regions of (A), (B), (C), . . . are set in the input region 32.

As shown in FIG. 4A, image display of the limited frame 50 may follow the shape of the input member 5 so as to easily correspond to the flat input member 5. That is, a square frame 51 having a shape similar to the input pad 7 may be displayed on an image of the limited frame 50, and a writing limit region 52 may be provided inside the square frame 51. This writing limit region 52 may correspond to the writing region 17 of the input pad 7 shown in FIG. 2. Moreover, an imitated button image 53 which imitates the right button and an imitated button image 54 which imitates the left button 9 may be displayed on the limited frame 50. The imitated button images 53 and 54 may not contribute to writing of a character into the input region 32 of the handwriting tool board 30. However, since the imitated button images 53 and 54 move sequentially rightward together with the writing limit region 52, the operator easily understands intuitively that a writing portion using the input member 5 moves rightward.

A part or all of the image of the limited frame 50 may be transparent or translucent. As shown in FIG. 4A, when the limited frame 50 is displayed on the handwriting tool board 30 so as to overlap each other, it may be possible to view an image of the handwriting tool board 30 displayed behind an image of the limited frame 50. Thus, by making the limited frame 50 as an image through which can be viewed, writing can be performed while viewing the shapes of both the handwriting tool board 30 and the limited frame 50.

When the limited frame setting application software 26 starts, the limited frame 50 may be displayed as shown in FIG. 4A but at the same time, a cursor displayed on the screen of the display device 6 moves to the inside of the writing limit region 52. As described above, the limited frame 50 may move from the first region (A) to the second region (B) and further move to the third region (C) at predetermined intervals. In this case, however, the cursor within the writing limit region 52 also may move rightward together with the limited frame 50.

When a finger touches the writing region 17 of the input pad 7 while the limited frame 50 stops to be displayed in one region, the cursor may move to a position, which may correspond to the position where the finger touches the writing region 17, in the writing limit region 52. That is, the writing region 17 of the input pad 7 and the writing limit region 52 of the limited frame 50 may have approximately similar shapes. In addition, when a finger touches the writing region 17, the cursor may move to a position similar to the finger touch position in the writing limit region 52. Thereafter, the cursor may move only inside the writing limit region 52, and the locus when the finger touches and moves in the writing region 17 of the input pad 7 may be displayed as a locus in the writing limit region 52.

When the limited frame 50 moves rightward in a predetermined time, the locus of a character or the like written by hand in the writing limit region 52 of the limited frame 50 may be transferred to the input region 32 of the handwriting tool board 30 located below the writing limit region 52. Then, the locus in the writing limit region 52 of the limited frame 50 having moved rightward may be deleted, resulting in a state where writing of a next character or the like is waited.

As shown in FIG. 4A, when the locus of handwriting, such as a character written in the limited frame 50, is transferred to the input region 32 of the handwriting tool board 30, the locus of the handwritten character may be left behind in the input region 32. Then, when the locus of the handwritten character moves to the character input tool board 40 shown in FIG. 4B, font display of the type of a character determined to be closest to the locus of the handwritten character may be selected and the font may be displayed on the character input tool board 40.

Also, when the limited frame 50 moves from the first region (A) to the second region (B), a character, a number, or a symbol closest to the locus drawn on the limited frame 50 in the first region (A) may be determined immediately after the movement or after a predetermined time has elapsed and the character, the number, or the symbol may be transferred and displayed in the type form in the first region (A) of the handwriting tool board 30 on the basis of a font corresponding to the character, the number, or the symbol determined.

Whenever the limited frame 50 moves rightward as described above, characters may be transferred to the input region 32 of the handwriting tool board 30. When the number of characters in the input region 32 reaches a predetermined number, the character string may move to the character input tool board 40 and may be displayed as a string of the font of the type.

The cursor displayed on the display screen of the display device 6 may move only in the writing limit region 52 of the limited frame 50. However, if a finger taps one place of the input screen 7a of the input pad 7, for example, the operation region 18g once or twice while writing a character, the limited frame 50 may stop to the position and may not move rightward and an operation of writing the locus of a character or the like in the writing limit region 52 may be interrupted. In addition, by pressing the right button 8 shown in FIG. 2, the movement of the limited frame 50 may be stopped similarly and the character writing operation may be interrupted. While the writing operation is being interrupted, the locus is not drawn within the limited frame 50 or the locus may not be changed even if the input pad 7 is operated to move the cursor.

In addition, if a finger touching the input screen 7a of the input pad 7 moves while continuously pressing the left button 9 of the input member 5 or the finger touching the input screen 7a may move after pressing the left button 9 once while the limited frame 50 is being displayed, a movement range of the cursor on the screen may no longer be restricted to the inside of the limited frame 50, such that the cursor can move anywhere on the display screen. Accordingly, a switching operation, such as deletion or insertion of a character, may be performed by moving the cursor to one instructing portion within the operation panel 34 and performing tapping at the position. Also, the minimize button 31a or the close button 31b may also be operated. In addition, a character or the like may be deleted by moving a cursor to a position of the character within the display region 41 of the character input tool board 40 and pressing a ‘Delete button’ of the keyboard device 4.

In order to resume writing of a character into the limited frame 50, pressing of the left button 9 may be stopped or the left button 9 may be pressed once again. Thereafter, when the finger touching the input screen 7a moves, the cursor may move within the limited frame 50 and writing of the locus may be resumed.

In addition, by an operation, such as tapping one of the operation regions 18a to 18h set on the input screen 7a of the input pad 7 while the limited frame 50 is being displayed, writing of a character is interrupted thereafter and the cursor can be moved to the outside of the limited frame 50. Furthermore, the writing of a character within the limited frame 50 may be resumed by tapping the same place.

Furthermore, in the case when various operation functions are assigned to the divided operation regions 18a to 18h on the input screen 7a of the input pad 7 shown in FIG. 2, the same switching input as operating the operation panel 34 can be realized by tapping one of the operation regions 18a to 18h after the writing of a character or the like is interrupted as described above.

By using the detection functions assigned to the operation regions 18a to 18h, the same operation as pressing the right button 8 or the same operation as pressing the left button 9 may be performed when one of the operation regions is tapped.

For example, when an operation region assigned with a function of the left button 9 is tapped, display of the limited frame 50 disappears in the same manner as pressing the left button 9. In addition, when an operation region assigned with a function of the left button 9 is tapped, the limited frame setting application software 26 may run to start the display of the limited frame 50.

In addition, functions assigned to the operation regions 18a to 18h may include deletion of a character, insertion of a character, and the like.

In the above embodiment, a case in which a character writing region in the input region 32 shifts rightward as the limited frame 50 moves rightward for every predetermined time has been described. However, for example, whenever the right button 8 is pressed or one of the operation regions 18a to 18h is tapped or one place of the input screen 7a is tapped, the limited frame 50 may move rightward so that a region used to write a character moves.

Alternatively, when a finger touching the input screen 7a of the input pad 7 is determined to be apart from the input screen 7a and the state continues for a predetermined period of time, the limited frame 50 may automatically move to a next region so that a region used to draw a character, a number, or a symbol moves rightward.

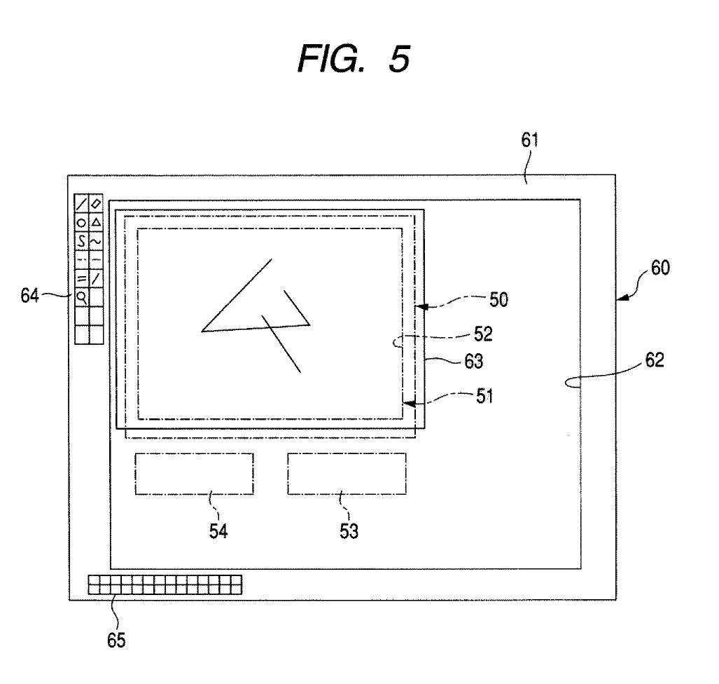

FIG. 5 shows a state where a drawing tool board 60, which is another input tool, is displayed on a display screen of the display device 6.

The drawing tool board 60 is displayed on the display screen when the input tool application software 25 starts.

The drawing tool board 60 may be used to draw a picture or drawing, and a drawing region 63 may be provided in an inner portion 62 of a frame body 61 such that the area of the drawing region 63 can be changed. A drawing selection icon 64 may be provided in the frame body 61. The type of line to be drawn may be selected or a standardized figure, such as a circle, may be displayed by pressing the right button 8 or tapping the input pad 7 in a state where a cursor is located at any place of the drawing selection icon 64. In addition, a color sample selecting portion 65 may be provided in a lower part of the frame body 61. By pressing the right button 8 or tapping the input pad 7 in a state where a cursor is located at one color of the color sample selecting portion 65, a color of a drawing line may be selected or the inside of a figure drawn may be colored.

When the left button 9 is pressed or one of the operation regions 18a to 18h of the input pad 7 is tapped while the drawing tool board 60 is being displayed, the limited frame 50 may be displayed on the screen of the display device 6 so as to overlap the drawing tool board 60 as shown in FIG. 5.

In addition, the cursor can move only within the writing limit region 52 of the limited frame 50. Also in this case, a place touched by a finger in the writing region 17 of the input pad 7 may be similar to a writing place of the locus in the writing limit region 52. Accordingly, a figure or a picture can be finely drawn using the input pad 7.

In addition, the display position of the limited frame 50 overlapping the drawing tool board 60 may be moved by tapping one of the operation regions 18a to 18h assigned to the input screen 7a of the input pad 7 and moving a finger. Furthermore, the size of the limited frame 50 may be changed as described above so that drawing is performed in a state where a region used to draw a figure and the like is changed within the drawing tool board 60.

Also in this case, it may be possible to assign various operation functions, such as ‘delete’, ‘insert’, and ‘move’, to the operation regions 18a to 18h.

It should be understood by those skilled in the art that various modifications, combinations, sub-combinations and alternations may occur depending on design requirements and other factors insofar as they are within the scope of the appended claims of the equivalents thereof. Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. The claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the inventions. Many modifications to the embodiments described above can be made without departing from the spirit and scope of the invention.

1. An input processing device comprising:
an input member having an input pad and a detecting section that detects a position where an indicator touches the input pad; and
a processing module that controls a display state on a display screen on the basis of an input signal obtained from the input member,
wherein while an input tool for drawing at least one of character, symbol, and figure is being displayed on the display screen, the processing module displays a limited frame having a predetermined area on the display screen so as to overlap the input tool, and writes movement locus of the indicator touching the input pad within the limited frame and transfers the movement locus to the input tool such that at least one of the character, symbol, and figure is input to the input tool when the indicator touches the input pad.

2. The input processing device according to claim 1,
wherein an image of the limited frame is displayed such that an image of the input tool is viewed therethrough.

3. The input processing device according to claim 1,
wherein an image of the limited frame has a shape similar to the input pad.

4. The input processing device according to claim 1,
wherein processing for sequentially moving a display position of the limited frame within the input tool displayed on the display screen at predetermined intervals is performed.

5. The input processing device according to claim 1,
wherein when a predetermined time elapses after the indicator is apart from the input pad, processing for moving a display position of the limited frame within the input tool displayed on the display screen is performed.

6. The input processing device according to claim 1,
wherein the input pad is divided into a writing region used to write at least one of the character, symbol, and figure and an operation region other than the writing region, and
processing for deleting at least one of the character, symbol, and figure transferred into the input tool or inserting at least one of the character, symbol, and figure is performed.

7. The input processing device according to claim 1,
wherein an operation of writing at least one of the character, symbol, and figure within the limited frame is released when a specific input operation is performed on the input member, and processing for moving the cursor displayed on the display screen without being restricted to the limited frame is performed when the indicator moves on the input pad after the release.

8. The input processing device according to claim 7,
wherein the specific input operation includes an operation of tapping the input pad with the indicator.

9. The input processing device according to claim 7,
wherein the specific input operation is performed by operating a press button provided together with the input pad.

10. The input processing device according to claim 1,
wherein the processing section is executed by software installed in a control unit of a personal computer, and
the input tool is also executed by software installed in the control unit.

11. The input processing device according to claim 10,
wherein the processing module is executed by driver software that gives coordinate information to an operating system in the control unit on the basis of the input signal from the input member and limited frame setting application software that sets the limited frame.
